(19) United States
(12) Patent Application Publication
(10) Pub. No.: US 2008/0303413 A1
(43) Pub. Date: Dec. 11, 2008

(54) Electroluminescent Panel and Method for the Production Thereof

(76) Inventors: Christoph Thalner, Neunkirchen (AT); Edouard Marc Meyer, Neuchatel (CH); Alexander Singer, La Chaux-de-Fonds (CH)

Correspondence Address: NEXSEN PRUET, LLC, PO DRAWER 2426, COLUMBIA, SC, 29202-2426, US

(21) Appl. No.: 11/631,982

(22) PCT Filed: Jul. 8, 2005
(86) PCT No.: PCT/EP05/53293

§ 371 Date: Jun. 30, 2008

(30) Foreign Application Priority Data
Jul. 14, 2004 (EP) 04405447.6

(51) Int. Cl. H05B 33/20; H05B 33/22; H05B 33/26

(52) U.S. Cl. 313/504; 445/24; 313/506; 313/509

(57) ABSTRACT

The invention relates to an electroluminescent panel arrangement (10) having a dielectric (11), an active layer (12), and first (13) and second electrodes (14) which are disposed on the side of the bottom and the front of the panel, respectively, and are connectable to a voltage generator (15). The second electrode (14) is made of a transparent material. The dielectric (11), the active layer (12) and the first electrode (13) are individually coated with active substance and binder dry residues. The binder is identical to the dielectric (11) for the active layer (12) and the first electrode (13). According to the invention, the binder contains 60-70% solvent mixture, 5-15% PVC, 35-10% acrylate, 0-5%, typically less than 0.5%, oleic acid amide.

The present invention relates to the field of electroluminescent (EL) light sources. More particularly, it relates to an electroluminescent panel and a method for producing same.

The principle of electroluminescence is widely known. It relies on the fact that certain substances emit light when they are subjected to an electric voltage.

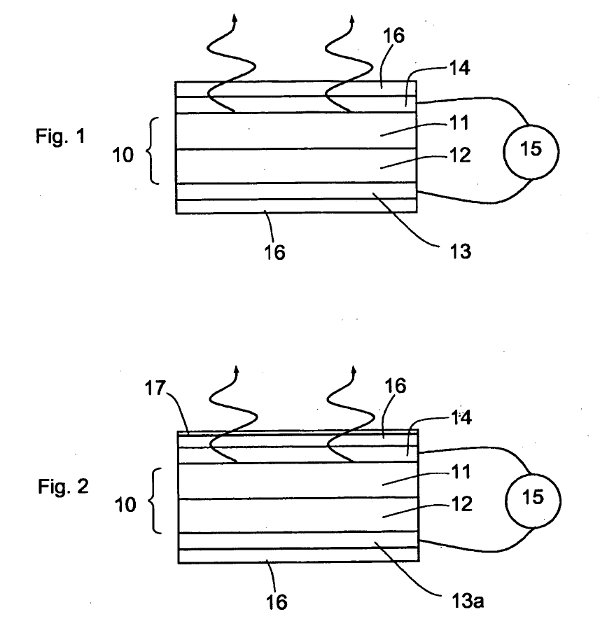

There are already EL panels with the structure illustrated in FIG. 1. An assembly 10 consisting of an active layer 11 superimposed on a dielectric layer 12 of the same size is gripped between two electrodes, one 13 at the rear and one 14 at the front of the panel. These are connected to a generator 15 and apply an electric voltage to the assembly 10. Finally, two layers 16 of transparent laminate form the outer surfaces of the panel and protect the functional parts.

The active layer and the dielectric each contain various active substances known to those skilled in the art, mixed with a binder.

Various experimental tests have shown that the results obtained with the usual substances and binders could be considerably improved.

Moreover, the bottom electrode 13 is made of platings that make it rigid. Thus, the profile of the panel obtained cannot be adapted to any support, such as a curved wall. Sometimes, this electrode is formed by a thin metal sheet. The latter provides for a panel with a certain flexibility, but this solution is particularly difficult and costly to implement for large-sized panels.

Document WO 01/15496 describes the possibility of using a single binder for the various layers forming the EL panel.

The object of the present invention is to provide a panel with operating qualities that are significantly enhanced, particularly by optimizing the composition of the binder, and making it more flexible to use. The invention also proposes a method for obtaining such a panel.

More specifically, the invention relates to an electroluminescent panel of the type comprising an assembly consisting of a dielectric and an active layer, and a first and a second electrode respectively located on the bottom side and on the front of the panel, designed for connection to a voltage generator. The second electrode is made of a transparent material. The dielectric, the active layer and said first electrode each comprise an active substance and dry residues of a binder that is identical for the dielectric, the active layer and the first electrode.

According to the invention, the binder comprises:
between 60 and 70% a solvent mixture,
between 5 and 15% PVC,
between 35 and 10% acrylate, and
between 0 and 5%, typically less than 0.5%, oleic acid amide.

Advantageously, the bottom electrode comprises a layer whose active substance is polyaniline and/or a layer whose active substance is another conductive material.

The invention also relates to a method for producing an EL panel, comprising the following steps:
acquiring the electrode intended to be located at the front of the panel,
depositing the active layer on this electrode,
depositing the dielectric on the active layer, and
depositing the rear electrode on the dielectric.

The panel can also be produced by a method which comprises the following steps:
acquiring an inert support,
depositing the first electrode on this support,
depositing the dielectric on the first electrode,
depositing the active layer on the dielectric, and
depositing the second electrode on the active layer.

In the two embodiments, the deposition operations are carried out by screen printing.

The invention also relates to the use of a binder in the production of an EL panel. This binder is the sole binder used in the production of said panel. It comprises:
between 60 and 70% a solvent mixture,
between 5 and 15% PVC,
between 35 and 10% acrylate, and
between 0 and 5%, typically less than 0.5%, oleic acid amide.

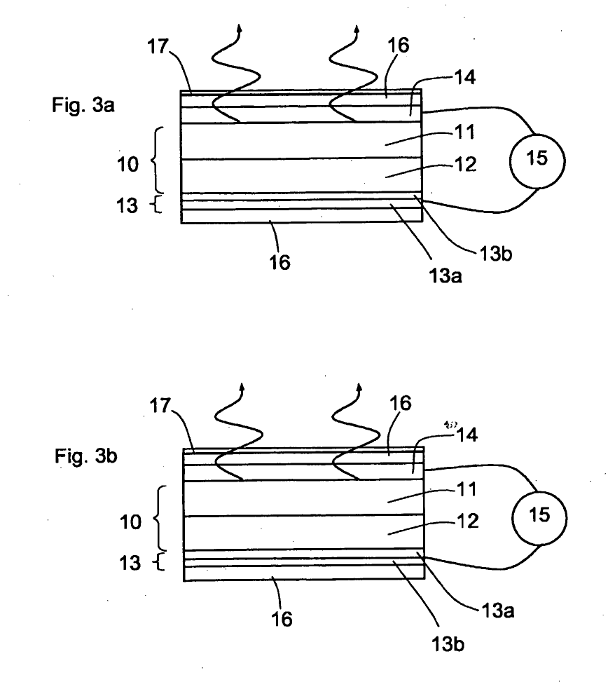

Other characteristics will become more clearly apparent from reading the description that follows, given with reference to the appended drawing, in which the FIGS. 2, 3a and 3b present a number of embodiments of an EL panel.

As in the prior art, the EL panel comprises an assembly 10 comprising an active layer 11 and a dielectric 12 (FIG. 2).

The active layer 11 is prepared from a paste comprising doped zinc sulphide, called “phosphor”, a binder and the usual additives, such as solvents, dispersants or retarders. If necessary, pigments can be added to modify the spectrum of the light emitted by the layer. After elimination of the solvents, the active layer 11 comprises between 65 and 95%, typically 88%, phosphor, and between 35 and 5%, typically 12%, an organic matrix comprising the dry residues of the binder and of the various compounds present in the paste.

The dielectric 12 is prepared from a paste comprising barium titanate, a binder and the usual additives. After elimination of the solvents, the dielectric comprises between 65 and 95%, typically 85%, barium titanate, and between 35 and 5%, typically 15%, an organic matrix comprising the dry residues of the binder and of the various compounds present in the paste.

A first electrode 13 is superimposed on the assembly 10, on the bottom side of the panel. It comprises a layer 13a prepared from a paste comprising silver powder, a binder and the usual additives. After elimination of the solvents, the electrode 13 comprises between 65 and 95%, typically 85%, silver, and between 35 and 5%, typically 15%, an organic matrix comprising the dry residues of the binder and of the various compounds present in the paste. The silver can be replaced by various conductive materials, such as copper or even graphite for small electrodes.

To form the electrode 13, a layer 13b prepared from a paste comprising polyaniline, a binder and the usual additives can possibly replace or be added to the layer 13a. In this second eventuality, as shown by FIGS. 3a and 3b, the layer of polyaniline can be deposited equally on one side or the other of the layer of silver.

The assembly 10 is covered, on the front side of the panel, by a second electrode 14. The latter can be made of a transparent conductive layer disposed on a substrate. The materials chosen for the electrode and for the substrate must be conductive, transparent to the light emitted by the assembly 10 and have a good affinity with each other. For example, it may be a layer of indium and tin oxide deposited on a polyester support.

Advantageously, the electrode can not only be conductive and transparent, but also flexible. In this case, it can be made of a lacquer containing indium and tin oxide applied directly to the dielectric 11 or a layer of fine particles of silver or of zinc oxide, deposited on a support, for example made of polyester. This way, the resulting panel is perfectly adaptable to the surface to which it is applied.

The electrodes 13 and 14 are designed to be connected to a generator 15 to apply an electric voltage to the assembly 10.

Conventionally, one or two protective sheets 16 insulate the electrodes from external attack. Finally, a transparent film 17 bearing the pattern that the panel must illuminate is disposed according to known techniques on the protective sheet 16 located on the front of the panel. The pattern can also be printed directly on the front electrode 14.

The overall thickness of the panel, without the protective sheet, is typically between 0.3 and 5 mm.

Advantageously, the binder used to form the pastes is the same for the dielectric 12, for the active layer 11 and for the bottom electrode 13. As an example, it comprises:
between 60 and 70%, typically 64%, a solvent mixture,
between 5 and 15%, typically 8.5%, PVC,
between 35 and 10%, typically around 27%,
acrylate, and
between 0 and 5%, typically less than 0.5%, oleic acid amide.

The solvent mixture comprises:
between 25 and 65% xylene,
less than 2.5% of 3,5,5-trimethyl-2-cylclohexen-2-one,
between 2.5 and 10% cyclohexanone,
less than 2.5% 2-methoxy-1-methylacetate,
less than 2.5% 1,2,4-trimethylbenzene, and
less than 2.5% naphtha.

The table below compares some operating characteristics of a panel of the prior art with those of an EL panel of the same area obtained according to a preferred embodiment of the invention. In the latter:
the active layer 11 has been prepared from a paste comprising 72% phosphor and 28% binder to which are added pigments to form a mixture comprising 71.20% phosphor, 27.70% binder, 0.58% orange pigment, 0.52% pink pigment;
the dielectric 12 has been prepared with a paste comprising 66% barium titanate, 34% binder; and
the bottom electrode has been prepared with a paste comprising 66% powder silver and 34% binder.

| | Panel of the | Panel according |
|---|---|---|
| | prior art | to the invention |
| Half-life | 850 h | >5000 h |
| Brightness | 95 cd/m2 | >100 cd/m2 |
| Relative energy | 100% | Approximately 50% |
| consumption | | |
| Panel size | Typically up to | Up to A0 and |
| | A2 | above |

It will be remembered that the half-life is the time required for the brightness to reduce by half.

For the production of the panel as claimed in the invention, the various layers are formed and assembled by screen printing. This technique is known to those skilled in the art and will not therefore be described in detail. It will simply be noted that, to fix a layer on a substrate, said technique comprises a step of application of the mixture forming said layer on a fabric of predetermined mesh, disposed on the substrate. The viscosity of the mixture is such that, by applying a pressure to it, it passes through the fabric and is spread uniformly on the substrate. After drying, the layer adheres to the substrate.

For the panel described above, the order of assembly of the layers can be as follows: front electrode 14, active layer 11, dielectric 12 and rear electrode 13. These layers are dried, either one after the other, after each application, or all together, at the end.

As a variant, the order of assembly can be: rear electrode, dielectric, active layer, front electrode. In this case, an inert substrate is used as a basis for the application of the rear electrode.

Then, the protective sheet(s) 16 and the film 17 bearing the pattern are disposed as explained above, according to the techniques known to those skilled in the art.

Evidently, the two assembly variants above can also be applied to the case where the rear electrode has a silver-based layer and/or a polyaniline-based layer.

It will be noted that, because the bottom electrode 13, silver- and/or polyaniline-based, can be deposited by screen printing, the layer obtained is flexible. Since it is the same for all the other layers, particularly when the front electrode 14 is flexible, the panel adapts itself perfectly to the shape of the support to which it is applied, which constitutes a major advantage of the invention.

The composition of the dielectric used means that it can be applied in one go. The insulation that it provides is adequate and the drawback of the EL panels having multiple layers of dielectric, namely a very short life span, is avoided.

Moreover, the above method does not require any particular precautions to be taken for its implementation. For example, the use of a clean room is not essential, unlike the usual practice. The industrial production of the EL panels according to the invention is therefore greatly facilitated.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. An electroluminescent panel comprising an assembly comprising a dielectric and an active layer, and a first and a second electrode respectively located on the bottom side and on the front of the panel, designed for connection to a voltage generator, said second electrode being made of a transparent material, said dielectric, said active layer and said first electrode each comprising an active substance and dry residues of a binder, said binder being identical for said dielectric, for said active layer and for said first electrode, said binder comprising:
between 60 and 70% a solvent mixture,
between 5 and 15% PVC,
between 35 and 10% acrylate, and
between 0 and 5%, typically less than 0.5%, oleic acid amide.

15. The panel of claim 14, wherein said first electrode comprises a layer whose active substance is polyaniline and/or a layer whose active substance is another conductive material.

16. The panel of claim 14, wherein said binder comprising:
64% a solvent mixture,
8.5% PVC,
27% acrylate, and
less than 0.5% oleic acid amide.

17. The panel of claim 14, wherein the solvent mixture comprises:
between 25 and 65% xylene,
less than 2.5% of 3,5,5-trimethyl-2-cylclohexen-2-one,
between 2.5 and 10% cyclohexanone,
less than 2.5% 2-methoxy-1-methylacetate,
less than 2.5% 1,2,4-trimethylbenzene, and
less than 2.5% naphtha.

18. The panel of claim 15, wherein the solvent mixture comprises:
between 25 and 65% xylene,
less than 2.5% of 3,5,5-trimethyl-2-cylclohexen-2-one,
between 2.5 and 10% cyclohexanone,
less than 2.5% 2-methoxy-1-methylacetate,
less than 2.5% 1,2,4-trimethylbenzene, and
less than 2.5% naphtha.

19. The panel of claim 16, wherein the solvent mixture comprises:
between 25 and 65% xylene,
less than 2.5% of 3,5,5-trimethyl-2-cylclohexen-2-one,
between 2.5 and 10% cyclohexanone,
less than 2.5% 2-methoxy-1-methylacetate,
less than 2.5% 1,2,4-trimethylbenzene, and
less than 2.5% naphtha.

20. The panel as claimed of claim 15, wherein said binder comprises:
64% a solvent mixture,
8.5% PVC,
27% acrylate, and
less than 0.5% oleic acid amide.

21. The panel as claimed of claim 20, wherein the solvent mixture comprises:
between 25 and 65% xylene,
less than 2.5% of 3,5,5-trimethyl-2-cylclohexen-2-one,
between 2.5 and 10% cyclohexanone,
less than 2.5% 2-methoxy-1-methylacetate,
less than 2.5% 1,2,4-trimethylbenzene, and
less than 2.5% naphtha.

22. The panel of claim 14, wherein said active layer is made of a mixture comprising between 65 and 95% phosphor and between 35 and 5% organic dry residues.

23. The panel of claim 15, wherein said active layer is made of a mixture comprising between 65 and 95% phosphor and between 35 and 5% organic dry residues.

24. The panel of claim 16, wherein said active layer is made of a mixture comprising between 65 and 95% phosphor and between 35 and 5% organic dry residues.

25. The panel of claim 20, wherein said active layer is made of a mixture comprising between 65 and 95% phosphor and between 35 and 5% organic dry residues.

26. The panel of claim 22, wherein said active layer is supplemented with at least one pigment, the quantity of which is approximately 0.5% of said mixture.

27. The panel of claim 23, wherein said active layer is supplemented with at least one pigment, the quantity of which is approximately 0.5% of said mixture.

28. The panel of claim 24, wherein said active layer is supplemented with at least one pigment, the quantity of which is approximately 0.5% of said mixture.

29. The panel of claim 25, wherein said active layer is supplemented with at least one pigment, the quantity of which is approximately 0.5% of said mixture.

30. The panel of claim 14, wherein said dielectric is formed of a mixture comprising between 65 and 95% barium titanate and between 35 and 5% organic dry residues.

31. The panel of claim 15, wherein said dielectric is formed of a mixture comprising between 65 and 95% barium titanate and between 35 and 5% organic dry residues.

32. The panel of claim 16, wherein said dielectric is formed of a mixture comprising between 65 and 95% barium titanate and between 35 and 5% organic dry residues.

33. The panel of claim 20, wherein said dielectric is formed of a mixture comprising between 65 and 95% barium titanate and between 35 and 5% organic dry residues.

34. The panel of claim 14, wherein:
the active layer is prepared from a paste comprising 72% phosphor and 28% binder,
the dielectric is prepared from a paste comprising 66% barium titanate and 34% binder, and
the first electrode is prepared from a paste comprising 66% powder silver and 34% binder.

35. The panel of claim 15, wherein:
the active layer is prepared from a paste comprising 72% phosphor and 28% binder,
the dielectric is prepared from a paste comprising 66% barium titanate and 34% binder, and
the first electrode is prepared from a paste comprising 66% powder silver and 34% binder.

36. The panel of claim 16, wherein:
the active layer is prepared from a paste comprising 72% phosphor and 28% binder,
the dielectric is prepared from a paste comprising 66% barium titanate and 34% binder, and
the first electrode is prepared from a paste comprising 66% powder silver and 34% binder.

37. The panel of claim 20, wherein:
the active layer is prepared from a paste comprising 72% phosphor and 28% binder,
the dielectric is prepared from a paste comprising 66% barium titanate and 34% binder, and
the first electrode is prepared from a paste comprising 66% powder silver and 34% binder.

38. The panel of claim 14, wherein it also comprises at least one protective sheet disposed on said second electrode.

39. The panel of claim 15, wherein it also comprises at least one protective sheet disposed on said second electrode.

40. The panel of claim 16, wherein it also comprises at least one protective sheet disposed on said second electrode.

41. The panel of claim 20, wherein it also comprises at least one protective sheet disposed on said second electrode.

42. The panel of claim 38, wherein it also comprises a transparent film bearing the pattern that the panel must illuminate and disposed on said protective sheet located on the front of the panel.

43. A method of producing the EL panel of claim 14, comprising the following steps:
acquiring said second electrode,
depositing said active layer on said second electrode,
depositing said dielectric on said active layer, and
depositing said first electrode on said dielectric,
the deposition operations being formed by screen printing.

44. A method of producing the EL panel of claim 14, comprising the following steps:
acquiring an inert support,
depositing said first electrode on said support,
depositing said dielectric on said first electrode,
depositing said active layer on said dielectric, and
depositing said second electrode on said active layer,
the deposition operations being performed by screen printing.

45. Use of a single binder in the production of the EL panel of claim 14, characterized in that the binder comprises:
between 60 and 70% a solvent mixture,
between 5 and 15% PVC,
between 35 and 10% acrylate, and
between 0 and 5%, typically less than 0.5%, oleic acid amide.
